(19) United States
(12) Patent Application Publication
(10) Pub. No.: US 2024/0306156 A1
(43) Pub. Date: Sep. 12, 2024

(54) PHYSICAL UPLINK CONTROL CHANNEL TRANSMISSION SLOT DETERMINATION

(71) Applicant: Nokia Technologies Oy, Espoo (FI)

(72) Inventors: Klaus HUGL, Vienna (AT); Kari Juhani HOOLI, Oulu (FI); Juha Sakari KORHONEN, Espoo (FI)

(21) Appl. No.: 18/578,475

(22) PCT Filed: Aug. 5, 2021
(86) PCT No.: PCT/EP2021/071938

§ 371 Date: Jan. 11, 2024

(51) Int. Cl. H04W 72/21; H04L 5/00; H04W 72/0446

(52) U.S. Cl. CPC H04W 72/21; H04L 5/0055; H04W 72/0446

(57) ABSTRACT

Devices, methods and computer programs for a packet data unit session for physical uplink control channel transmission slot determination are disclosed. A client device receives from a network node device physical uplink control channel, PUCCH, configuration information for configuring more than one serving cell for a PUCCH transmission within a PUCCH cell group for the client device. The PUCCH configuration information comprises at least one set of relative slot offset values n for at least one target serving cell for the PUCCH transmission having a larger sub-carrier spacing, SCS, than an SCS of a reference cell. The client device utilizes the received PUCCH configuration information in selecting a PUCCH transmission slot for a target serving cell.

### TECHNICAL FIELD

The disclosure relates generally to communications and, more particularly but not exclusively, to physical uplink control channel transmission slot determination.

### BACKGROUND

In the context of, e.g., fifth generation (5G) new radio (NR) wireless networks, the term “numerology” is used to refer to subcarrier spacings (SCS). For example, 5G NR may comprise five different numerologies or subcarrier spacings: 15 kHz, 30 kHz, 60 kHz, 120 kHz and 240 kHz. Depending the numerology used, slot length gets different: as subcarrier spacing gets wider, slot length gets shorter.

When a physical downlink shared channel (PDSCH) is scheduled, a base station may indicate a slot for a physical uplink control channel (PUCCH) in which a hybrid automatic repeat request acknowledgement (HARQ-ACK) of the PDSCH is mapped. In case of time division duplex (TDD) operation, this means that the PUCCH carrying the HARQ-ACK may need to be delayed in time to guarantee that the symbols for the PUCCH transmission are valid for the PUCCH transmission.

Due to the use of multiple different numerologies or subcarrier spacings, at least in some situations there may be more than one slot on a larger SCS PUCCH target cell coinciding with a single slot of a PUCCH reference cell. Accordingly, at least in some situations there may be a need to define which slot the PUCCH is to be transmitted on the larger SCS carrier.

### SUMMARY

The scope of protection sought for various example embodiments of the disclosure is set out by the independent claims. The example embodiments and features, if any, described in this specification that do not fall under the scope of the independent claims are to be interpreted as examples useful for understanding various example embodiments of the disclosure.

An example embodiment of a client device comprises at least one processor, and at least one memory including computer program code. The at least one memory and the computer program code are configured to, with the at least one processor, cause the client device to at least perform:
receiving from a network node device physical uplink control channel, PUCCH, configuration information for configuring more than one serving cell for a PUCCH transmission within a PUCCH cell group for the client device, the PUCCH configuration information comprising at least one set of relative slot offset values n for at least one target serving cell for the PUCCH transmission having a larger sub-carrier spacing, SCS, than an SCS of a reference cell; and
utilizing the received PUCCH configuration information in selecting a PUCCH transmission slot for a target serving cell of the at least one target serving cell.

In an example embodiment, alternatively or in addition to the above-described example embodiments, the PUCCH configuration information includes a separate PUCCH configuration per each uplink, UL, bandwidth part, BWP, of the at least one target serving cell, and wherein a set of the at least one set of relative slot offset values n for the PUCCH transmission is indicated with a radio resource control, RRC, parameter.

In an example embodiment, alternatively or in addition to the above-described example embodiments, the PUCCH configuration information includes a single PUCCH configuration for all the at least one target serving cell, and the at least one set of the relative slot offset values n for the at least one target serving cell for the PUCCH transmission is one of: common for all the at least one target serving cell, target cell specific, uplink bandwidth part specific, or sub-carrier spacing specific, and is indicated with a radio resource control, RRC, parameter.

In an example embodiment, alternatively or in addition to the above-described example embodiments, the RRC parameter comprises a DataToUL-ACK or a DataToUL-ACK_rel_offset.

In an example embodiment, alternatively or in addition to the above-described example embodiments, the utilizing of the received PUCCH configuration information in selecting the PUCCH transmission slot further comprises:
based on a PUCCH transmission slot on the reference cell and a relative slot offset value n of the target serving cell for a PUCCH transmission of an uplink control information, UCI, transmission, determining a PUCCH transmission slot of the UCI transmission on the target serving cell as the (n+1)^{th} slot on the target serving cell overlapping with the PUCCH transmission slot on the reference cell.

In an example embodiment, alternatively or in addition to the above-described example embodiments, the relative slot offset value n is indicated using a physical downlink shared channel to hybrid automatic repeat request acknowledgement, PDSCH-to-HARQ-ACK,_feedback timing indicator field in a downlink control information, DCI, scheduling a PDSCH or activating a semi-persistent scheduling, SPS, PDSCH configuration.

In an example embodiment, alternatively or in addition to the above-described example embodiments, the utilizing of the received PUCCH configuration information in selecting the PUCCH transmission slot further comprises:
determining an effective PDSCH-to-HARQ feedback offset based on the determined PUCCH transmission slot on the target serving cell and PDSCH allocation.

In an example embodiment, alternatively or in addition to the above-described example embodiments, the at least one memory and the computer program code are further configured to, with the at least one processor, cause the client device to perform determining an effective PDSCH-to-HARQ feedback offset value on the target serving cell based on a PDSCH allocation, a PDSCH-to-HARQ feedback offset value of a reference cell and the relative slot offset value n of the target serving cell, wherein determining of a slot on the target serving cell for a PUCCH transmission is performed using the determined effective PDSCH-to-HARQ feedback offset value.

In an example embodiment, alternatively or in addition to the above-described example embodiments, the at least one memory and the computer program code are further configured to, with the at least one processor, cause the client device to perform:
receiving from the network node device a time-domain pattern of an applicable PUCCH cell.

In an example embodiment, alternatively or in addition to the above-described example embodiments, the PUCCH configuration information further comprises a reference SCS to allow determination of timing and granularity of the time-domain pattern.

In an example embodiment, alternatively or in addition to the above-described example embodiments, the reference SCS comprises an SCS of a reference cell, the reference cell being indicated by the network node device, or the reference cell being a primary cell, Pcell, or a primary secondary cell, PScell, of the PUCCH cell group, or the reference cell being an UL serving cell with the lowest or highest serving cell index, or the reference cell being an UL serving cell applicable for PUCCH transmission with the highest SCS.

In an example embodiment, alternatively or in addition to the above-described example embodiments, the PUCCH configuration information further comprises an index of the cell used for the PUCCH transmission for each time-domain indication of the time-domain pattern.

In an example embodiment, alternatively or in addition to the above-described example embodiments, the utilizing of the received PUCCH configuration information in selecting the PUCCH transmission slot comprises:
determining the PUCCH transmission slot on the reference cell.

In an example embodiment, alternatively or in addition to the above-described example embodiments, the utilizing of the received PUCCH configuration information in selecting the PUCCH transmission slot further comprises:
determining the target serving cell for a PUCCH transmission of the UCI transmission based on the time-domain pattern and the determined PUCCH transmission slot on the reference cell.

An example embodiment of a client device comprises means for performing:
causing the client device to receive from a network node device physical uplink control channel, PUCCH, configuration information for configuring more than one serving cell for a PUCCH transmission within a PUCCH cell group for the client device, the PUCCH configuration information comprising at least one set of relative slot offset values n for at least one target serving cell for the PUCCH transmission having a larger sub-carrier spacing, SCS, than an SCS of a reference cell; and
utilizing the received PUCCH configuration information in selecting a PUCCH transmission slot for a target serving cell of the at least one target serving cell.

In an example embodiment, alternatively or in addition to the above-described example embodiments, the PUCCH configuration information includes a separate PUCCH configuration per each uplink, UL, bandwidth part, BWP, of the at least one target serving cell, and wherein a set of the at least one set of relative slot offset values n for the PUCCH transmission is indicated with a radio resource control, RRC, parameter.

In an example embodiment, alternatively or in addition to the above-described example embodiments, the PUCCH configuration information includes a single PUCCH configuration for all the at least one target serving cell, and the at least one set of the relative slot offset values n for the at least one target serving cell for the PUCCH transmission is one of: common for all the at least one target serving cell, target cell specific, uplink bandwidth part specific, or sub-carrier spacing specific, and is indicated with a radio resource control, RRC, parameter.

In an example embodiment, alternatively or in addition to the above-described example embodiments, the RRC parameter comprises a DataToUL-ACK or a DataToUL-ACK_rel_offset.

In an example embodiment, alternatively or in addition to the above-described example embodiments, the utilizing of the received PUCCH configuration information in selecting the PUCCH transmission slot further comprises:
based on a PUCCH transmission slot on the reference cell and a relative slot offset value n of the target serving cell for a PUCCH transmission of an uplink control information, UCI, transmission, determining a PUCCH transmission slot of the UCI transmission on the target serving cell as the (n+1)^{th} slot on the target serving cell overlapping with the PUCCH transmission slot on the reference cell.

In an example embodiment, alternatively or in addition to the above-described example embodiments, the relative slot offset value n is indicated using a physical downlink shared channel to hybrid automatic repeat request acknowledgement, PDSCH-to-HARQ-ACK,_feedback timing indicator field in a downlink control information, DCI, scheduling a PDSCH or activating a semi-persistent scheduling, SPS, PDSCH configuration.

In an example embodiment, alternatively or in addition to the above-described example embodiments, the utilizing of the received PUCCH configuration information in selecting the PUCCH transmission slot further comprises:
determining an effective PDSCH-to-HARQ feedback offset based on the determined PUCCH transmission slot on the target serving cell and PDSCH allocation.

In an example embodiment, alternatively or in addition to the above-described example embodiments, the means are further configured to perform determining an effective PDSCH-to-HARQ feedback offset value on the target serving cell based on a PDSCH allocation, a PDSCH-to-HARQ feedback offset value of a reference cell and the relative slot offset value n of the target serving cell, wherein determining of a slot on the target serving cell for a PUCCH transmission is performed using the determined effective PDSCH-to-HARQ feedback offset value.

In an example embodiment, alternatively or in addition to the above-described example embodiments, the means are further configured to perform causing the client device to receive from the network node device a time-domain pattern of an applicable PUCCH cell.

In an example embodiment, alternatively or in addition to the above-described example embodiments, the PUCCH configuration information further comprises a reference SCS to allow determination of timing and granularity of the time-domain pattern.

In an example embodiment, alternatively or in addition to the above-described example embodiments, the reference SCS comprises an SCS of a reference cell, the reference cell being indicated by the network node device, or the reference cell being a primary cell, Pcell, or a primary secondary cell, PScell, of the PUCCH cell group, or the reference cell being an UL serving cell with the lowest or highest serving cell index, or the reference cell being an UL serving cell applicable for PUCCH transmission with the highest SCS.

In an example embodiment, alternatively or in addition to the above-described example embodiments, the PUCCH configuration information further comprises an index of the cell used for the PUCCH transmission for each time-domain indication of the time-domain pattern.

In an example embodiment, alternatively or in addition to the above-described example embodiments, the utilizing of the received PUCCH configuration information in selecting the PUCCH transmission slot comprises:
determining the PUCCH transmission slot on the reference cell.

In an example embodiment, alternatively or in addition to the above-described example embodiments, the utilizing of the received PUCCH configuration information in selecting the PUCCH transmission slot further comprises:
determining the target serving cell for a PUCCH transmission of the UCI transmission based on the time-domain pattern and the determined PUCCH transmission slot on the reference cell.

An example embodiment of a method comprises:
receiving, at a client device from a network node device, physical uplink control channel, PUCCH, configuration information for configuring more than one serving cell for a PUCCH transmission within a PUCCH cell group for the client device, the PUCCH configuration information comprising at least one set of relative slot offset values n for at least one target serving cell for the PUCCH transmission having a larger sub-carrier spacing, SCS, than an SCS of a reference cell; and
utilizing, by the client device, the received PUCCH configuration information in selecting a PUCCH transmission slot for a target serving cell of the at least one target serving cell.

In an example embodiment, alternatively or in addition to the above-described example embodiments, the PUCCH configuration information includes a separate PUCCH configuration per each uplink, UL, bandwidth part, BWP, of the at least one target serving cell, and wherein a set of the at least one set of relative slot offset values n for the PUCCH transmission is indicated with a radio resource control, RRC, parameter.

In an example embodiment, alternatively or in addition to the above-described example embodiments, the PUCCH configuration information includes a single PUCCH configuration for all the at least one target serving cell, and the at least one set of the relative slot offset values n for the at least one target serving cell for the PUCCH transmission is one of: common for all the at least one target serving cell, target cell specific, uplink bandwidth part specific, or sub-carrier spacing specific, and is indicated with a radio resource control, RRC, parameter.

In an example embodiment, alternatively or in addition to the above-described example embodiments, the RRC parameter comprises a DataToUL-ACK or a DataToUL-ACK_rel_offset.

In an example embodiment, alternatively or in addition to the above-described example embodiments, the utilizing of the received PUCCH configuration information in selecting the PUCCH transmission slot further comprises:
based on a PUCCH transmission slot on the reference cell and a relative slot offset value n of the target serving cell for a PUCCH transmission of an uplink control information, UCI, transmission, determining a PUCCH transmission slot of the UCI transmission on the target serving cell as the (n+1)^{th} slot on the target serving cell overlapping with the PUCCH transmission slot on the reference cell.

In an example embodiment, alternatively or in addition to the above-described example embodiments, the relative slot offset value n is indicated using a physical downlink shared channel to hybrid automatic repeat request acknowledgement, PDSCH-to-HARQ-ACK,_feedback timing indicator field in a downlink control information, DCI, scheduling a PDSCH or activating a semi-persistent scheduling, SPS, PDSCH configuration.

In an example embodiment, alternatively or in addition to the above-described example embodiments, the utilizing of the received PUCCH configuration information in selecting the PUCCH transmission slot further comprises:
determining an effective PDSCH-to-HARQ feedback offset based on the determined PUCCH transmission slot on the target serving cell and PDSCH allocation.

In an example embodiment, alternatively or in addition to the above-described example embodiments, the method further comprises determining an effective PDSCH-to-HARQ feedback offset value on the target serving cell based on a PDSCH allocation, a PDSCH-to-HARQ feedback offset value of a reference cell and the relative slot offset value n of the target serving cell, wherein determining of a slot on the target serving cell for a PUCCH transmission is performed using the determined effective PDSCH-to-HARQ feedback offset value.

In an example embodiment, alternatively or in addition to the above-described example embodiments, the method further comprises receiving from the network node device a time-domain pattern of an applicable PUCCH cell.

In an example embodiment, alternatively or in addition to the above-described example embodiments, the PUCCH configuration information further comprises a reference SCS to allow determination of timing and granularity of the time-domain pattern.

In an example embodiment, alternatively or in addition to the above-described example embodiments, the reference SCS comprises an SCS of a reference cell, the reference cell being indicated by the network node device, or the reference cell being a primary cell, Pcell, or a primary secondary cell, PScell, of the PUCCH cell group, or the reference cell being an UL serving cell with the lowest or highest serving cell index, or the reference cell being an UL serving cell applicable for PUCCH transmission with the highest SCS.

In an example embodiment, alternatively or in addition to the above-described example embodiments, the PUCCH configuration information further comprises an index of the cell used for the PUCCH transmission for each time-domain indication of the time-domain pattern.

In an example embodiment, alternatively or in addition to the above-described example embodiments, the utilizing of the received PUCCH configuration information in selecting the PUCCH transmission slot comprises:
determining the PUCCH transmission slot on the reference cell.

In an example embodiment, alternatively or in addition to the above-described example embodiments, the utilizing of the received PUCCH configuration information in selecting the PUCCH transmission slot further comprises:
determining the target serving cell for a PUCCH transmission of the UCI transmission based on the time-domain pattern and the determined PUCCH transmission slot on the reference cell.

An example embodiment of a computer program comprises instructions for causing a client device to perform at least the following:
receiving from a network node device physical uplink control channel, PUCCH, configuration information for configuring more than one serving cell for a PUCCH transmission within a PUCCH cell group for the client device, the PUCCH configuration information comprising at least one set of relative slot offset values n for at least one target serving cell for the PUCCH transmission having a larger sub-carrier spacing, SCS, than an SCS of a reference cell; and
utilizing the received PUCCH configuration information in selecting a PUCCH transmission slot for a target serving cell of the at least one target serving cell.

An example embodiment of a network node device comprises at least one processor, and at least one memory including computer program code. The at least one memory and the computer program code are configured to, with the at least one processor, cause the network node device to at least perform:
generating physical uplink control channel, PUCCH, configuration information for configuring more than one serving cell for a PUCCH transmission within a PUCCH cell group for a client device, the PUCCH configuration information comprising at least one set of relative slot offset values n for at least one target serving cell for the PUCCH transmission having a larger a sub-carrier spacing, SCS, than an SCS of a reference cell;
transmitting the generated PUCCH configuration information to the client device; and receiving uplink control information from the client device on the PUCCH or a physical uplink shared channel, PUSCH, based on the PUCCH configuration information.

In an example embodiment, alternatively or in addition to the above-described example embodiments, the at least one memory and the computer program code are further configured to, with the at least one processor, cause the network node device to perform transmitting to the client device a time-domain pattern of an applicable PUCCH cell.

An example embodiment of a network node device comprises means for performing:
generating physical uplink control channel, PUCCH, configuration information for configuring more than one serving cell for a PUCCH transmission within a PUCCH cell group for a client device, the PUCCH configuration information comprising at least one set of relative slot offset values n for at least one target serving cell for the PUCCH transmission having a larger sub-carrier spacing, SCS, than an SCS of a reference cell;
causing the network node device to transmit the generated PUCCH configuration information to the client device; and
causing the network node device to receive uplink control information from the client device on the PUCCH or a physical uplink shared channel, PUSCH, based on the PUCCH configuration information.

In an example embodiment, alternatively or in addition to the above-described example embodiments, the means are further configured to cause the network node device to transmit to the client device a time-domain pattern of an applicable PUCCH cell.

An example embodiment of a method comprises:
generating, by a network node device, physical uplink control channel, PUCCH, configuration information for configuring more than one serving cell for a PUCCH transmission within a PUCCH cell group for a client device, the PUCCH configuration information comprising at least one set of relative slot offset values n for at least one target serving cell for the PUCCH transmission having a larger sub-carrier spacing, SCS, than an SCS of a reference cell;
transmitting the generated PUCCH configuration information from the network node device to the client device; and
receiving uplink control information from the client device on the PUCCH or a physical uplink shared channel, PUSCH, based on the PUCCH configuration information.

In an example embodiment, alternatively or in addition to the above-described example embodiments, the method further comprises transmitting to the client device a time-domain pattern of an applicable PUCCH cell.

An example embodiment of a computer program comprises instructions for causing a network node device to perform at least the following:
generating physical uplink control channel, PUCCH, configuration information for configuring more than one serving cell for a PUCCH transmission within a PUCCH cell group for a client device, the PUCCH configuration information comprising at least one set of relative slot offset values n for at least one target serving cell for the PUCCH transmission having a larger sub-carrier spacing, SCS, than an SCS of a reference cell;
transmitting the generated PUCCH configuration information to the client device; and
receiving uplink control information from the client device on the PUCCH or a physical uplink shared channel, PUSCH, based on the PUCCH configuration information.

### DESCRIPTION OF THE DRAWINGS

The accompanying drawings, which are included to provide a further understanding of the embodiments and constitute a part of this specification, illustrate embodiments and together with the description help to explain the principles of the embodiments. In the drawings:

FIG. 1 shows an example embodiment of the subject matter described herein illustrating an example system, where various embodiments of the present disclosure may be implemented;

FIG. 2A shows an example embodiment of the subject matter described herein illustrating an example client device, where various embodiments of the present disclosure may be implemented;

FIG. 2B shows an example embodiment of the subject matter described herein illustrating an example network node device, where various embodiments of the present disclosure may be implemented;

FIG. 3 shows an example embodiment of the subject matter described herein illustrating a method;

FIG. 4 shows an example embodiment of the subject matter described herein illustrating another method;

FIG. 5 illustrates PUCCH slot determination on a target serving cell based on a relative offset indication; and

FIG. 6 illustrates determination of an effective PDSCH-to-HARQ feedback offset.

Like reference numerals are used to designate like parts in the accompanying drawings.

### DETAILED DESCRIPTION

Reference will now be made in detail to embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

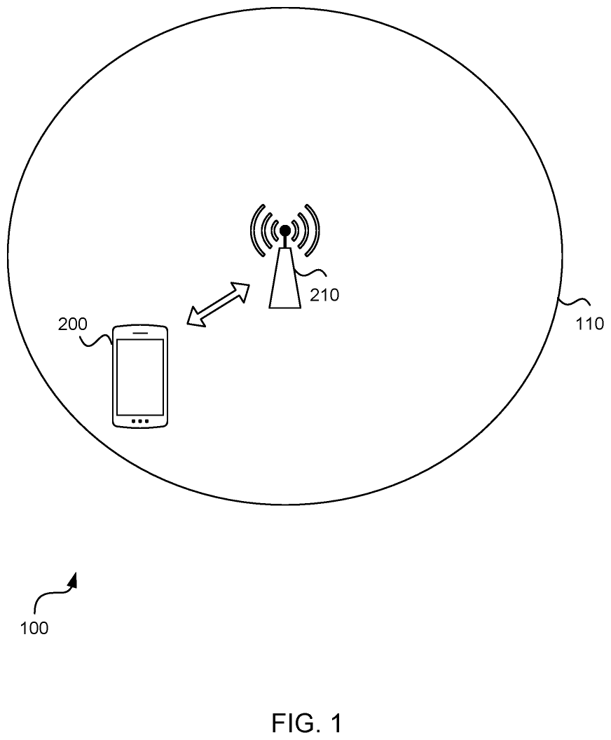

FIG. 1 illustrates an example system 100, where various embodiments of the present disclosure may be implemented. The system 100 may comprise a fifth generation (5G) new radio (NR) network 110. An example representation of the system 100 is shown depicting a client device 200 and a network node device 210. At least in some embodiments, the 5G NR network 110 may comprise one or more massive machine-to-machine (M2M) network(s), massive machine type communications (mMTC) network(s), internet of things (IoT) network(s), industrial internet-of-things (IIoT) network(s), enhanced mobile broadband (eMBB) network(s), ultra-reliable low-latency communication (URLLC) network(s), and/or the like. In other words, the 5G NR network 110 may be configured to serve diverse service types and/or use cases, and it may logically be seen as comprising one or more networks.

The client device 200 may include, e.g., a mobile phone, a smartphone, a tablet computer, a smart watch, or any hand-held, portable and/or wearable device. The client device 200 may also be referred to as a user equipment (UE). The network node device 210 may be a base station. The base station may include, e.g., a fifth-generation base station (gNB) or any such device suitable for providing an air interface for client devices to connect to a wireless network via wireless transmissions.

The delay of HARQ-ACK transmission may become problematic in TDD operation if PUCCH resources are configured only for one cell. To reduce the latency, PUCCH resources may be configured for multiple cells whose TDD UL-DL patterns are not identical. Then opportunities for PUCCH transmission may be more frequent than with only one PUCCH cell. With multiple PUCCH cells, one of the cells is a reference cell whose numerology at least partly determines the timing of the HARQ-ACK transmission. The cell where the PUCCH transmission takes place is called a PUCCH target cell. It may be semi-statically configured which of the PUCCH cells is a target cell at a particular time.

In the following, various example embodiments will be discussed. At least some of these example embodiments may allow physical uplink control channel transmission slot determination.

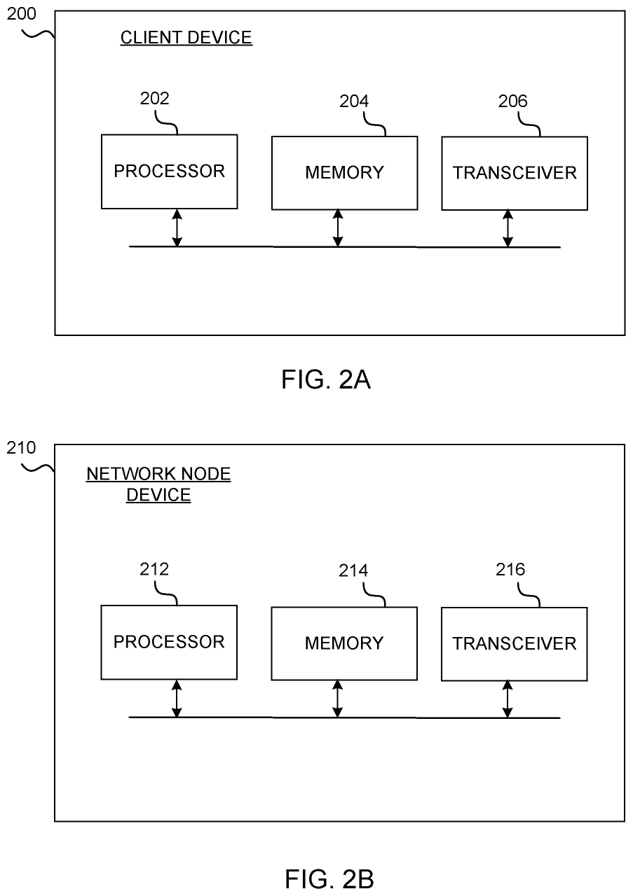

FIG. 2A is a block diagram of the client device 200, in accordance with an example embodiment.

The client device 200 comprises one or more processors 202 and one or more memories 204 that comprise computer program code. The client device 200 may also include other elements, such as a transceiver 206 configured to enable the client device 200 to transmit and/or receive information to/from other devices, as well as other elements not shown in FIG. 2A. In one example, the client device 200 may use the transceiver 206 to transmit or receive signaling information and data in accordance with at least one cellular communication protocol. The transceiver 206 may be configured to provide at least one wireless radio connection, such as for example a 3GPP mobile broadband connection (e.g., 5G). The transceiver 206 may comprise, or be configured to be coupled to, at least one antenna to transmit and/or receive radio frequency signals.

Although the client device 200 is depicted to include only one processor 202, the client device 200 may include more processors. In an embodiment, the memory 204 is capable of storing instructions, such as an operating system and/or various applications. Furthermore, the memory 204 may include a storage that may be used to store, e.g., at least some of the information and data used in the disclosed embodiments.

Furthermore, the processor 202 is capable of executing the stored instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash ROM, RAM (random access memory), etc.).

The client device 200 may comprise any of various types of devices used directly by an end user entity and capable of communication in a wireless network, such as user equipment (UE). Such devices include but are not limited to smartphones, tablet computers, smart watches, lap top computers, internet-of-things (IoT) devices, massive machine-to-machine (M2M) devices, massive machine type communications (mMTC) devices, industrial internet-of-things (IIoT) devices, enhanced mobile broadband (eMBB) devices, ultra-reliable low-latency communication (URLLC) devices, etc.

The at least one memory 204 and the computer program code are configured to, with the at least one processor 202, cause the client device 200 to at least perform receiving from the network node device 210 physical uplink control channel (PUCCH) configuration information for configuring more than one serving cell for a PUCCH transmission within a PUCCH cell group for the client device 200. The PUCCH configuration information comprises at least one set of relative slot offset values n for at least one target serving cell for the PUCCH transmission having a larger (i.e., wider or higher) sub-carrier spacing (SCS) than an SCS of a reference cell. The at least one set of relative slot offset values may be common for all target serving cells, or it may be target cell specific, or it may be uplink bandwidth part specific, or it may be SCS specific. Each target cell may have a different SCS, and the PUCCH may be transmitted at a target cell the SCS of which is larger than the SCS of the reference cell.

For example, the subcarrier spacings may comprise 15 kHz, 30 kHz, 60 kHz, 120 kHz and 240 kHz. For example, a 30 kHz SCS is larger than a 15 kHz SCS, and so on. As subcarrier spacing gets larger, slot length gets shorter.

The at least one memory 204 and the computer program code are further configured to, with the at least one processor 202, cause the client device 200 to perform utilizing the received PUCCH configuration information in selecting a PUCCH transmission slot for a target serving cell of the at least one target serving cell having a larger SCS than an SCS of a reference cell.

In at least some embodiments, the PUCCH configuration information may include a separate PUCCH configuration per each uplink (UL) bandwidth part (BWP) of the at least one target serving cell. A set of the at least one set of relative slot offset values n for the target serving cells for the PUCCH transmission having a larger SCS than an SCS of a reference cell may be indicated with a radio resource control (RRC) parameter. For example, the RRC parameter may comprise a DataToUL-ACK or a DataToUL-ACK_rel_offset.

In at least some embodiments, the PUCCH configuration information may include a single PUCCH configuration for all the at least one target serving cell.

The at least one set of the relative slot offset values n for the at least one target serving cell for the PUCCH transmission may be one of: common for all target serving cells, target cell specific, uplink bandwidth part specific, or sub-carrier spacing specific, and may be indicated with an RRC parameter. For example, the RRC parameter may comprise a DataToUL-ACK_rel_offset. In other words, the RRC parameter may comprise, e.g., a PUCCH target cell specific DataToUL-ACK_rel_offset, or SCS specific sets DataToUL-ACK_rel_offset which may be applicable for all target PUCCH cells of the same SCS.

In at least some embodiments, the at least one memory 204 and the computer program code may be further configured to, with the at least one processor 202, cause the client device 200 to perform receiving from the network node device 210 a time-domain pattern of an applicable PUCCH cell. For example, granularity of the time-domain pattern may be fixed or it may be configurable to the client device 200. Furthermore, the granularity of the time-domain pattern may be in multiple of slots (N slots) or symbols (M symbols). In at least some embodiments, the granularity may be two symbols, seven symbols for a normal cyclic prefix (CP), six symbols for an extended CP, or a slot to align with a PUCCH configuration of allowing slot or sub-slot based PUCCH configuration. The periodicity of the time-domain pattern may be fixed or based on an RRC configuration. In at least some embodiments, a configurable periodicity may have same candidate values as a TDD UL/downlink (DL) configuration (e.g., 0.5, 0.625, 1, 1.25, 2, 2.5, 3, 4, 5 and 10 ms).

In at least some embodiments, the PUCCH configuration information may further comprise a reference SCS to allow determination of timing and granularity of the time-domain pattern. For example, the reference SCS may be a directly configured parameter. In another example (e.g., for cases of mixed SCS of different applicable UL serving target cells), the reference SCS may comprise an SCS of a reference cell. The reference cell may be indicated (e.g., implicitly determined or explicitly configured) by the network node device 210. Alternatively, the reference cell may be a primary cell, Pcell, or a primary secondary cell, PScell, of the PUCCH cell group. In at least some embodiments, the implicitly determined reference cell may be an UL serving cell with the lowest or highest serving cell index. In at least some embodiments, the implicitly determined reference cell may be an UL serving cell applicable for PUCCH transmission with the highest SCS. In a case of more than one cell with the highest SCS, the UL serving cell with the lowest or highest serving cell index may be used.

In at least some embodiments, the PUCCH configuration information may further comprise an index of the cell used for the PUCCH transmission for each time-domain indication or time-domain instance of the time-domain pattern. For example, the index of the PUCCH cell may be given by the RRC configuration (e.g., a specific PUCCH cell index, 0 . . . K−1 for K PUCCH target cells), or it may be implicitly given by the serving cell index. For example, for two cells available for a PUCCH transmission, a single bit (0 or 1) may indicate the applicable PUCCH cell for a given time instant.

In at least some embodiments, the utilizing of the received PUCCH configuration information in selecting the PUCCH transmission slot may comprise determining the PUCCH transmission slot on the reference cell. For example, one of the cells of the client device 200 in a PUCCH cell group may serve as a timing reference cell whose slot/sub-slot configuration may be used to determine the timing from a physical downlink shared channel (PDSCH) transmission to a HARQ-ACK transmission according to the timing parameter in a downlink control information (DCI) that schedules PDSCH (k1) or activates a semi-persistent scheduling (SPS) PDSCH transmission. In at least some embodiments, this may be the PCell.

Herein, “k1” refers to a parameter that may be used to indicate the time delay between a PDSCH slot and a UCI (Ack/Nack) slot. In other words, HARQ ACK/NACK timing for a specific PDSCH may be configured by specifying the parameter k1.

In at least some embodiments, the utilizing of the received PUCCH configuration information in selecting the PUCCH transmission slot may further comprise determining a target serving cell for PUCCH transmission of an uplink control information (UCI) transmission based on the time-domain pattern and the determined PUCCH transmission slot on the reference cell.

In at least some embodiments, the utilizing of the received PUCCH configuration information in selecting the PUCCH transmission slot on the determined PUCCH target cell may further comprise: based on the determined PUCCH transmission slot on the reference cell and the relative slot offset value n of the determined target serving cell, determining the PUCCH transmission slot of the UCI transmission on the determined target serving cell as the (n+1)st target serving cell slot overlapping with the determined PUCCH transmission slot on the reference cell. For example, the relative slot offset value n may be indicated using a PDSCH-to-HARQ-ACK_feedback timing indicator field in a DCI scheduling a PDSCH or activating an SPS PDSCH configuration.

In at least some embodiments, the utilizing of the received PUCCH configuration information in selecting the PUCCH transmission slot may further comprise determining an effective PDSCH-to-HARQ feedback offset (e.g., the k1_{SCell} described in more detail below) based on the determined PUCCH transmission slot on a determined target serving cell and PDSCH allocation.

In at least some embodiments, the at least one memory 204 and the computer program code may be further configured to, with the at least one processor 202, cause the client device 200 to perform determining an effective PDSCH-to-HARQ feedback offset (e.g., the k1_{SCell}) value on the target serving cell based on PDSCH allocation, a PDSCH-to-HARQ feedback offset value of the reference cell and the relative slot offset value n of the target serving cell. The determining of the target serving cell slot for the PUCCH transmission may then be performed using the determined effective PDSCH-to-HARQ feedback offset (e.g., the k1_{SCell}) value.

In at least some embodiments, the at least one memory 204 and the computer program code may be further configured to, with the at least one processor 202, cause the client device 200 to perform UCI multiplexing and PUCCH resource determination according to the configuration used on the determined PUCCH target cell for the PUCCH transmission in the determined PUCCH target cell slot.

In at least some embodiments, the at least one memory 204 and the computer program code may be further configured to, with the at least one processor 202, cause the client device 200 to perform checking and/or determining the validity of a PUCCH resource on the determined cell for the PUCCH transmission. E.g., the UL/DL pattern of the determined cell for PUCCH may be used in the validity check. If the PUCCH resource is not valid, the PUCCH and the related UCI may be dropped.

In at least some embodiments, the at least one memory 204 and the computer program code may be further configured to, with the at least one processor 202, cause the client device 200 to perform a UCI transmission on a PUCCH or a physical uplink shared channel (PUSCH). If the resulting PUCCH resource is overlapping even partially with a PUSCH in any serving UL cell, the UCI may be mapped on the overlapping PUSCH. Otherwise, the PUCCH may be transmitted on the determined cell for the PUCCH transmission.

In other words, the disclosure allows the PUCCH slot on the target PUCCH cell to be determined as a combination of PDSCH time, an indicated PCell k1 value, and an indicated Scell k1_rel value from a set of values relative to a single PCell slot boundary.

More specifically, the client device 200 may determine the slot for the reference cell based on the PDSCH allocation, the PDSCH-to-HARQ-ACK_feedback timing indicator, and the configured set of k1 values of the reference cell (e.g., interpreted based on the numerology of the reference cell), and based on the determined slot and the configured time domain pattern the client device 200 may determine the target PUCCH cell.

For a target PUCCH cell of a larger SCS, the client device 200 may determine the slot for PUCCH transmission as the (n+1)st slot of the target PUCCH cell of the larger SCS overlapping with the determined slot of the PCell/reference cell, where the value of n may be indicated by the PDSCH-to-HARQ-ACK_feedback timing indicator from the set of Scell (in other words, target PUCCH cell) k1_rel values, configured by a dl-DataToUL-ACK on an Scell or by another RRC parameter, such as DataToUL-ACK_rel_offset.

The relative slot offset may be applied within a single slot of the smaller SCS PCell/reference cell to determine the (n+1)st slot of the larger SCS SCell/target cell overlapping with the PCell/reference cell slot. Therefore, the value range of {0, . . . , 2^{(μ}^{_{SCell}}^{-μ}^{_{PCell}}⁾−1} may be used to cover all the overlapping slots of the larger SCS within a PUCCH slot of a lower SCS.

For the PUCCH carrier switching operation based on semi-static configured time-domain pattern, the RRC parameter dl-DataToUL-ACK may be used, but for a joint operation of dynamic indication and semi-static operation using the configured time domain pattern an independent RRC parameter, such as DataToUL-ACK_rel_offset may be used to provide an absolute k1 value for the dynamic indication and the relative, intra-slot referencing for the larger SCS target cell (e.g., Scell).

The client device 200 may determine the effective k1 value for the target PUCCH cell based on the PDSCH allocation as well as the determined slot for PUCCH transmission on the target cell of larger SCS.

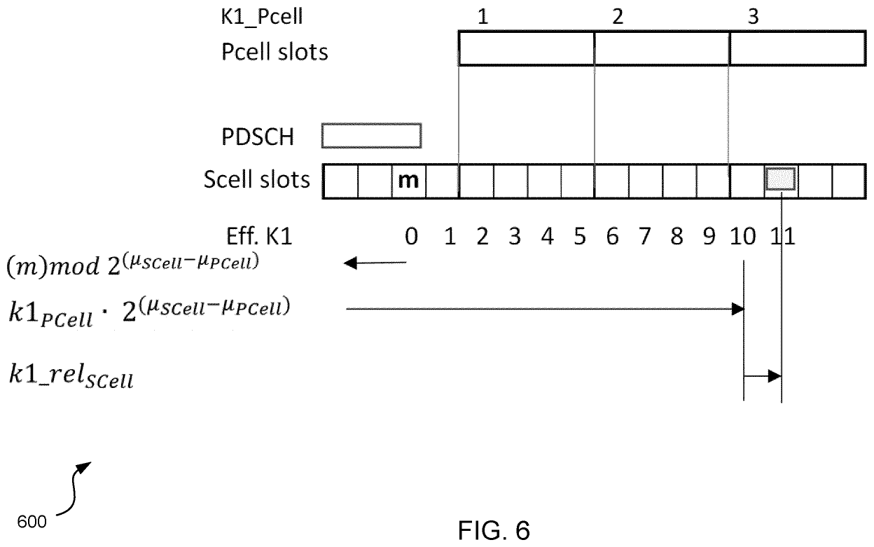

Diagram 600 of FIG. 6 illustrates the determination of an effective PDSCH-to-HARQ feedback offset. The effective k1_{SCell} value on the target PUCCH cell may be determined as:

$$k {1}_{SCell} = k {1}_{PCell} \cdot {2}^{( {μ}_{SCell} - {μ}_{PCell} )} + {k 1\_ rel}_{SCell} - ( m ) mod {2}^{( {μ}_{SCell} - {μ}_{PCell} )}$$

where k1_{PCell} is the value indicated by the PDSCH-to-HARQ-ACK_feedback timing indicator from the set of Pcell k1 values, k1_rel_{SCell} is the value indicated by the PDSCH-to-HARQ-ACK_feedback timing indicator from the set of Scell k1_rel values, and m is the last Scell PUCCH slot overlapping with the PDSCH.

The effective k1_{SCell} value on the target PUCCH cell may be used as an alternative method for the above operation of determining the slot for PUCCH transmission as the (n+1)st slot of the target PUCCH cell of the larger SCS overlapping with the determined slot of the PCell/reference cell. That is, the effective k1_{SCell} value on the target PUCCH cell may be determined first, to then determine the target slot for the PUCCH transmission using k1_{SCell}.

Diagram 500 of FIG. 5 illustrates PUCCH slot determination on a target serving cell based on a relative offset indication depending on the end of the PDSCH with the related k1 value mapping of reference cell numerology or a cell of a smaller SCS and an SCell a of larger configuration.

In the examples of FIG. 5, the following configurations are used:
on a PCell/reference cell, the network node device 210 configures {0,0,1,1,2,2,3,3} as the set of values for a dl-DataToUL-ACK, and
on an SCell/target cell, the network node device 210 configures {0,1,0,1,0,1,0,1} as the set of offset values n for a dl-DataToUL-ACK or a dl-DataToUL-ACK_rel_offset.

In the case of diagram 500 in which the PDSCH is ending in slot #0 on the PCell/reference cell and slot #1 on the larger SCS SCell/target cell, if the network node device 210 wishes to have the PUCCH transmission carrying the HARQ-ACK e.g. in slot #4 on the Scell/target cell—and assuming the example k1 and n value configuration described above, the network node device 210 may indicate {100} for the PDSCH-to-HARQ-ACK_feedback timing indicator which corresponds to k1=2 on the PCell/reference cell and offset n=1. As a result, the client device 200 determines the slot on the PCell/reference cell to be slot #2, and based on the n=1 determines that the 1^{st}/n^{th} slot is slot #4 on the SCell/target cell where the PUCCH transmission on the Scell/target cell is to take place. If needed, the client device 200 may further determine the effective k1 value on the Scell to be k1_eff=3.

As can be seen from the examples above, the number of usable states of the PDSCH-to-HARQ-ACK_feedback timing indicator is large. Especially in case k1=0 on PCell/reference cell is not configured, all the eight states of the PDSCH-to-HARQ-ACK_feedback timing indicator are fully usable. This may improve usable effective PDSCH-to-HARQ-ACK_feedback timing indication capabilities.

FIG. 2B is a block diagram of a network node device 210, in accordance with an example embodiment.

The network node device 210 comprises at least one processor 212 and at least one memory 214 including computer program code. The network node device 210 may also include other elements, such as a transceiver 216 configured to enable the network node device 210 to transmit and/or receive information to/from other devices, as well as other elements not shown in FIG. 2B. In one example, the network node device 210 may use the transceiver 216 to transmit or receive signaling information and data in accordance with at least one cellular communication protocol. The transceiver 216 may be configured to provide at least one wireless radio connection, such as for example a 3GPP mobile broadband connection (e.g., 5G). The transceiver 216 may comprise, or be configured to be coupled to, at least one antenna to transmit and/or receive radio frequency signals.

Although the network node device 210 is depicted to include only one processor 212, the network node device 210 may include more processors. In an embodiment, the memory 214 is capable of storing instructions, such as an operating system and/or various applications. Furthermore, the memory 214 may include a storage that may be used to store, e.g., at least some of the information and data used in the disclosed embodiments.

Furthermore, the processor 212 is capable of executing the stored instructions. In an embodiment, the processor 212 may be embodied as a multi-core processor, a single core processor, or a combination of one or more multi-core processors and one or more single core processors. For example, the processor 212 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 212 may be configured to execute hard-coded functionality. In an embodiment, the processor 212 is embodied as an executor of software instructions, wherein the instructions may specifically configure the processor 212 to perform the algorithms and/or operations described herein when the instructions are executed.

The memory 214 may be embodied as one or more volatile memory devices, one or more non-volatile memory devices, and/or a combination of one or more volatile memory devices and non-volatile memory devices. For example, the memory 214 may be embodied as semiconductor memories (such as mask ROM, PROM (programmable ROM), EPROM (erasable PROM), flash ROM, RAM (random access memory), etc.).

The network node device 210 may comprise a base station. The base station may include, e.g., a fifth-generation base station (gNB) or any such device providing an air interface for client devices to connect to the wireless network via wireless transmissions.

The at least one memory 214 and the computer program code are configured to, with the at least one processor 212, cause the network node device 210 to at least perform generating PUCCH configuration information for configuring more than one serving cell for a PUCCH transmission within a PUCCH cell group for the client device 200. The PUCCH configuration information comprises at least one set of relative slot offset values n for at least one target serving cell for the PUCCH transmission having a larger a sub-carrier spacing (SCS) than an SCS of a reference cell.

The at least one memory 214 and the computer program code are further configured to, with the at least one processor 212, cause the network node device 210 to perform transmitting the generated PUCCH configuration information to the client device 200.

In at least some embodiments, the at least one memory 214 and the computer program code may be further configured to, with the at least one processor 212, cause the network node device 210 to perform transmitting to the client device 200 a time-domain pattern of an applicable PUCCH cell.

The at least one memory 214 and the computer program code are further configured to, with the at least one processor 212, cause the network node device 210 to perform receiving uplink control information (UCI) from the client device 200 on the PUCCH or a physical uplink shared channel (PUSCH) based on the generated and transmitted PUCCH configuration information and optionally the time-domain pattern.

Further features of the network node device 210 directly result from the functionalities and parameters of the client device 200 and thus are not repeated here.

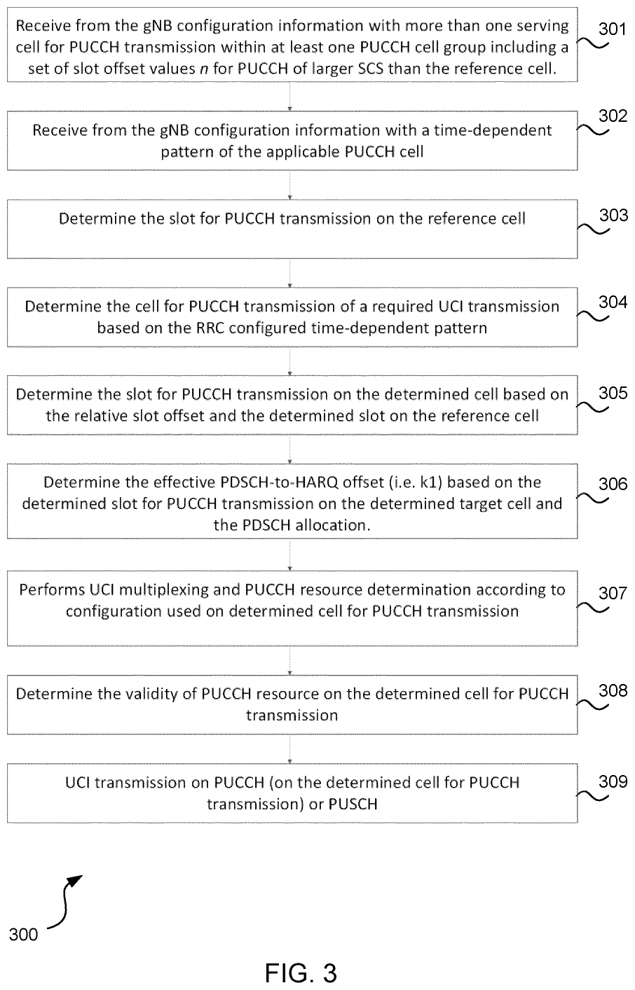

FIG. 3 illustrates an example flow chart of a method 300, in accordance with an example embodiment.

At operation 301, the client device 200 receives from the network node device 200 PUCCH configuration information for configuring more than one serving cell for a PUCCH transmission within a PUCCH cell group for the client device 200. As discussed above, the PUCCH configuration information comprises at least one set of relative slot offset values n for at least one target serving cell for the PUCCH transmission having a larger sub-carrier spacing (SCS) than an SCS of a reference cell.

At operations 302-309 (at least some of which are optional), the client device 200 may utilize the received PUCCH configuration information in selecting a PUCCH transmission slot for a target serving cell of the at least one target serving cell.

At optional operation 302, the client device 200 may receive from the network node device 200 a time-domain pattern of an applicable PUCCH cell.

At optional operation 303, the client device 200 may determine the PUCCH transmission slot on the reference cell.

At optional operation 304, the client device 200 may determine a target serving cell for PUCCH transmission of a UCI transmission based on the time-domain pattern and the determined PUCCH transmission slot on the reference cell.

At optional operation 305, the client device 200 may determine, based on the determined PUCCH transmission slot on the reference cell and the relative slot offset value n of the determined target serving cell, the PUCCH transmission slot of the UCI transmission on the determined target serving cell as the (n+1)st target serving cell slot overlapping with the determined PUCCH transmission slot on the reference cell.

At optional operation 306, the client device 200 may determine an effective PDSCH-to-HARQ feedback offset based on the determined PUCCH transmission slot on a determined target serving cell and PDSCH allocation.

At optional operation 307, the client device 200 may perform UCI multiplexing and PUCCH resource determination according to the configuration used on the determined cell for the PUCCH transmission in the determined target cell slot.

At optional operation 308, the client device 200 may check and/or determine the validity of a PUCCH resource on the determined cell for the PUCCH transmission.

At optional operation 309, the client device 200 may perform a UCI transmission on a PUCCH or a PUSCH.

The method 300 may be performed by the client device 200 of FIG. 2A. The operations 301-309 can, for example, be performed by the at least one processor 202 and the at least one memory 204. Further features of the method 300 directly result from the functionalities and parameters of the client device 200, and thus are not repeated here. The method 300 can be performed by computer program(s).

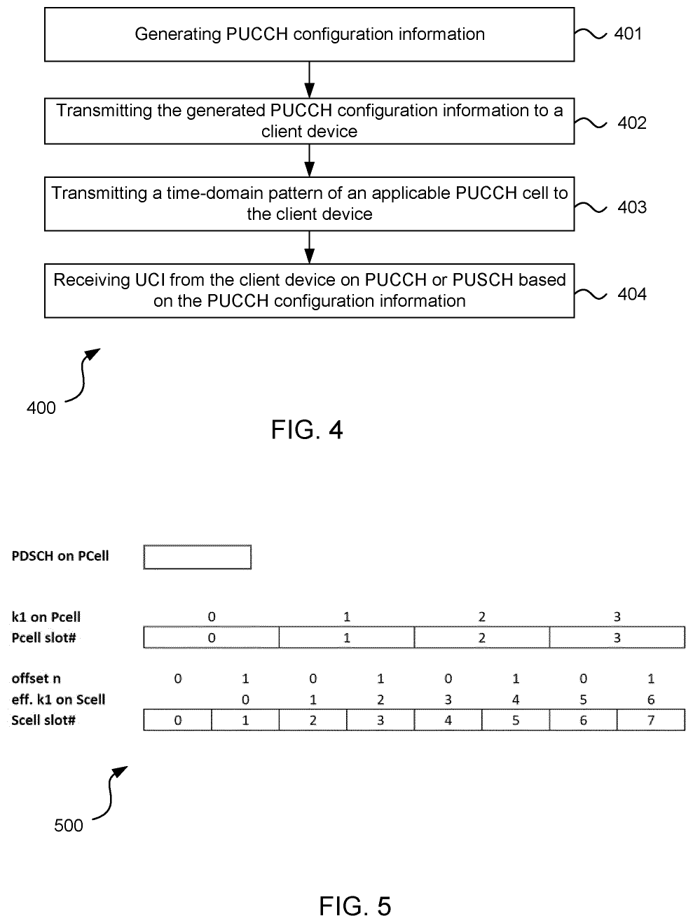

FIG. 4 illustrates an example flow chart of a method 400, in accordance with an example embodiment.

At operation 401, the network node device 210 generates PUCCH configuration information for configuring more than one serving cell for a PUCCH transmission within a PUCCH cell group for the client device 200. As discussed above, the PUCCH configuration information comprises at least one set of relative slot offset values n for at least one target serving cell for the PUCCH transmission having a larger sub-carrier spacing (SCS) than an SCS of a reference cell.

At operation 402, the network node device 210 transmits the generated PUCCH configuration information to the client device 200.

At optional operation 403, the network node device 210 transmits to the client device 200 a time-domain pattern of an applicable PUCCH cell.

At operation 404, the network node device 210 receives uplink control information (UCI) on the PUCCH or PUSCH from the client device 200 based on the generated and transmitted PUCCH configuration information of operation 402 and optionally the time-domain pattern of operation 403.

The method 400 may be performed by the network node device 210 of FIG. 2B. The operations 401-404 can, for example, be performed by the at least one processor 212 and the at least one memory 214. Further features of the method 400 directly result from the functionalities and parameters of the network node device 210, and thus are not repeated here. The method 400 can be performed by computer program(s).

At least some of the embodiments described herein may allow physical uplink control channel transmission slot determination.

At least some of the embodiments described herein may allow the network node device 210 (by configuration and indication through PDSCH-to-HARQ offset) to freely define the exact overlapping slot of a larger SCS PUCCH cell to be used for PUCCH transmission, giving more PUCCH scheduling flexibility to the network node device 210 and allowing configuration and/or indication of PUCCH load balancing by the network node device 210 between the different overlapping larger SCS slots.

At least some of the embodiments described herein may allow solving the problem of different needed combinations of k1 value pairs configured for PCell/reference cell and the larger SCS target cell for different PDSCH allocations within a smaller SCS carrier.

The client device 200 may comprise means for performing at least one method described herein. In one example, the means may comprise the at least one processor 202, and the at least one memory 204 including program code configured to, when executed by the at least one processor, cause the client device 200 to perform the method.

The network node device 210 may comprise means for performing at least one method described herein. In one example, the means may comprise the at least one processor 212, and the at least one memory 214 including program code configured to, when executed by the at least one processor, cause the network node device 210 to perform the method.

The functionality described herein can be performed, at least in part, by one or more computer program product components such as software components. According to an embodiment, the client device 200 and/or the network node device 210 may comprise a processor configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and Graphics Processing Units (GPUs).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1-19. (canceled)

20. A client device, comprising:
at least one processor; and
at least one memory including computer program code;
the at least one memory and the computer program code configured to, with the at least one processor, cause the client device to at least perform:
receiving from a network node device physical uplink control channel (PUCCH) configuration information for configuring more than one serving cell for a PUCCH transmission within a PUCCH cell group for the client device, the PUCCH configuration information comprising at least one set of relative slot offset values n for at least one target serving cell for the PUCCH transmission having a larger sub-carrier spacing (SCS) than an SCS of a reference cell; and
utilizing the received PUCCH configuration information in selecting a PUCCH transmission slot for a target serving cell of the at least one target serving cell.

21. The client device according to claim 20, wherein the PUCCH configuration information includes a separate PUCCH configuration per each uplink (UL) bandwidth part (BWP) of the at least one target serving cell, and wherein a set of the at least one set of relative slot offset values n for the PUCCH transmission is indicated with a radio resource control (RRC) parameter.

22. The client device according to claim 21, wherein the RRC parameter comprises a DataToUL-ACK or a DataToUL-ACK_rel_offset.

23. The client device according to claim 20, wherein the PUCCH configuration information includes a single PUCCH configuration for all the at least one target serving cell, and wherein the at least one set of the relative slot offset values n for the at least one target serving cell for the PUCCH transmission is one of:
common for all the at least one target serving cell,
target cell specific,
uplink bandwidth part specific, or
sub-carrier spacing specific,
and is indicated with a radio resource control (RRC) parameter.

24. The client device according to claim 23, wherein the RRC parameter comprises a DataToUL-ACK or a DataToUL-ACK_rel_offset

25. The client device according to claim 20, wherein the utilizing of the received PUCCH configuration information in selecting the PUCCH transmission slot further comprises:
based on a PUCCH transmission slot on the reference cell and a relative slot offset value n of the target serving cell for a PUCCH transmission of an uplink control information (UCI) transmission, determining a PUCCH transmission slot of the UCI transmission on the target serving cell as the (n+1)^{th} slot on the target serving cell overlapping with the PUCCH transmission slot on the reference cell.

26. The client device according to claim 25, wherein the relative slot offset value n is indicated using a physical downlink shared channel to hybrid automatic repeat request acknowledgement (PDSCH-to-HARQ-ACK)_feedback timing indicator field in a downlink control information (DCI) scheduling a PDSCH or activating a semi-persistent scheduling (SPS) PDSCH configuration.

27. The client device according to claim 26, wherein the utilizing of the received PUCCH configuration information in selecting the PUCCH transmission slot further comprises:
determining an effective PDSCH-to-HARQ feedback offset based on the determined PUCCH transmission slot on the target serving cell and PDSCH allocation.

28. The client device according to claim 20, wherein the at least one memory and the computer program code are further configured to, with the at least one processor, cause the client device to perform:
determining an effective PDSCH-to-HARQ feedback offset value on the target serving cell based on a PDSCH allocation, a PDSCH-to-HARQ feedback offset value of a reference cell and the relative slot offset value n of the target serving cell, wherein determining of a slot on the target serving cell for a PUCCH transmission is performed using the determined effective PDSCH-to-HARQ feedback offset value.

29. The client device according to claim 20, wherein the at least one memory and the computer program code are further configured to, with the at least one processor, cause the client device to perform:
receiving from the network node device a time-domain pattern of an applicable PUCCH cell.

30. The client device according to claim 29, wherein the PUCCH configuration information further comprises a reference SCS to allow determination of timing and granularity of the time-domain pattern.

31. The client device according to claim 30, wherein the reference SCS comprises an SCS of a reference cell, the reference cell being indicated by the network node device, or the reference cell being a primary cell (Pcell) or a primary secondary cell (PScell) of the PUCCH cell group, or the reference cell being an UL serving cell with the lowest or highest serving cell index, or the reference cell being an UL serving cell applicable for PUCCH transmission with the highest SCS.

32. The client device according to claim 27, wherein the PUCCH configuration information further comprises an index of the cell used for the PUCCH transmission for each time-domain indication of the time-domain pattern.

33. The client device according to claim 20, wherein the utilizing of the received PUCCH configuration information in selecting the PUCCH transmission slot comprises:
determining the PUCCH transmission slot on the reference cell.

34. The client device according to claim 33, wherein the utilizing of the received PUCCH configuration information in selecting the PUCCH transmission slot further comprises:
determining the target serving cell for a PUCCH transmission of the UCI transmission based on the time-domain pattern and the determined PUCCH transmission slot on the reference cell.

35. A method for a client device, comprising:
receiving, at the client device from a network node device, physical uplink control channel (PUCCH) configuration information for configuring more than one serving cell for a PUCCH transmission within a PUCCH cell group for the client device, the PUCCH configuration information comprising at least one set of relative slot offset values n for at least one target serving cell for the PUCCH transmission having a larger sub-carrier spacing (SCS) than an SCS of a reference cell; and
utilizing, by the client device, the received PUCCH configuration information in selecting a PUCCH transmission slot for a target serving cell of the at least one target serving cell.

36. The method according to claim 35, wherein the PUCCH configuration information includes a separate PUCCH configuration per each uplink (UL) bandwidth part (BWP) of the at least one target serving cell, and wherein a set of the at least one set of relative slot offset values n for the PUCCH transmission is indicated with a radio resource control (RRC) parameter.

37. The method according to claim 36, wherein the RRC parameter comprises a DataToUL-ACK or a DataToUL-ACK_rel_offset.

38. The method according to claim 35, wherein the PUCCH configuration information includes a single PUCCH configuration for all the at least one target serving cell, and wherein the at least one set of the relative slot offset values n for the at least one target serving cell for the PUCCH transmission is one of: common for all the at least one target serving cell, target cell specific, uplink bandwidth part specific, or sub-carrier spacing specific, and is indicated with a radio resource control (RRC) parameter.

39. A network node device, comprising:
at least one processor; and
at least one memory including computer program code;
the at least one memory and the computer program code configured to, with the at least one processor, cause the network node device to at least perform:
generating physical uplink control channel (PUCCH) configuration information for configuring more than one serving cell for a PUCCH transmission within a PUCCH cell group for a client device, the PUCCH configuration information comprising at least one set of relative slot offset values n for at least one target serving cell for the PUCCH transmission having a larger a sub-carrier spacing (SCS) than an SCS of a reference cell;
transmitting the generated PUCCH configuration information to the client device; and
receiving uplink control information from the client device on the PUCCH or a physical uplink shared channel (PUSCH) based on the PUCCH configuration information.
